(19) United States
(12) Patent Application Publication
(10) Pub. No.: US 2017/0058930 A1
(43) Pub. Date: Mar. 2, 2017

(54) QUICK-RELEASE COUPLING ASSEMBLY FOR UPRIGHT MEMBERS OF A WALKER APPARATUS

(71) Applicant: EVOLUTION TECHNOLOGIES INC., Port Coquitlam (CA)

(72) Inventor: Julian LIU, Port Moody (CA)

(21) Appl. No.: 15/254,665

(22) Filed: Sep. 1, 2016

Related U.S. Application Data
(60) Provisional application No. 62/213,572, filed on Sep. 2, 2015.

(51) Int. Cl. F16B 7/10; A61H 3/04

(52) U.S. Cl. CPC F16B 7/105; A61H 3/04; A61H 2201/0192; A61H 2201/1635; A61H 2201/0161; A61H 2201/1633

(57) ABSTRACT

There is provided an assembly for selectively coupling together elongate members, of a walker apparatus. The assembly includes-a push-responsive actuator actuation of a first portion, of which promotes coupling of the elongate members together. The assembly includes an actuator-engagement member moveable from an unengaged position spaced-apart from the, actuator to an engaged position in which the actuator-engagement member extends across and actuates the first portion of the actuator.

### BACKGROUND OF THE INVENTION

The present application claims priority from U.S. Provisional Patent Application No. 62/213,572 filed Sep. 2, 2015, the contents of which are incorporated-herein by reference.

### FIELD OF THE INVENTION

There is provided a coupling assembly. In particular, there is provided a coupling assembly for the upright members of a walker apparatus.

### DESCRIPTION OF THE RELATED ART

U.S. Pat. No. 5,188,139 to Garelick shows a weight-supporting walking aid. The walking aid has two side supports joined at the front to a crossmember by couplings which permit the side supports to be folded inward over the crossmember for storage and latch the side supports in the open position for normal use. The walking aid includes a locking mechanism to prevent rotation of side supports 10A and 10B in the form of a pin 30 seen in FIG. 4 thereof. The walking aid further includes a tab 35 that acts as a cantilevered spring arm so when depressed or pushed radially inward at its free end it pushes pin 30 against the force of spring 31 into the interior of vertical segment 15B. This disengages pin 30 from aperture 28 so that coupling 17B along with side support 10B can be rotated about segment 15B to fold up the walker.

U.S. Pat. No. 7,278,436 to Gale et al. shows a walker which includes a frame and two frame supports. The frame supports have arms and legs and are coupled to the frame to support the arms in elevated positions above ground underlying the frame. As seen in FIG. 25 thereof, the walker of Gale includes an outwardly-biased anti-rotation pin 591 and an actuator button 620. The actuator button is mounted for pivotable movement about pivot axis 622 on a button mount 610. The actuator button 620 is arranged to pivot in direction 625 about pivot axis 622 in response to application of force 124. This may intercept anti-rotation pin 591 as shown and disengage anti-rotation pin 591 from pin-receiving aperture 118 formed in first sleeve 34 to free first arm 16 for rotation about axis of rotation 15 relative to first sleeve 34.

### BRIEF SUMMARY OF INVENTION

There is provided an improved assembly for selectively coupling together elongate members of a walker apparatus.

There is provided ah assembly for selectively coupling together elongate members of a walker apparatus. The assembly includes a push-responsive actuator actuation of which promotes coupling of the elongate members together. The assembly includes an actuator-engagement member operatively coupled to the actuator. The actuator-engagement member is moveable from an unengaged position, in which movement of the actuator is unimpeded, to an engaged position in which the actuator-engagement member engages with the actuator so actuated and inhibits dislodgement thereof.

There is also provided an assembly for inhibiting movement of elongate members of a walker apparatus relative to each other. The assembly includes a push-responsive actuator. The assembly includes a lockpin operatively connected to the actuator, actuation of which causes the lockpin to couple together the elongate members. The assembly includes tin actuator-engagement member connectable to one of the elongate members. The actuator-engagement member is moveable from an unengaged position, in which movement of the actuator is unimpeded, to an engaged position in which the actuator-engagement member engages with the actuator so actuated and inhibits dislodgement thereof.

There is further provided a walker apparatus. The walker apparatus comprises a pair of telescoping elongate members. The walker apparatus further comprises a coupling assembly. The coupling assembly includes a push-responsive actuator actuation of which couples together the elongate members. The walker apparatus includes an actuator-engagement member coupled to one of the elongate members. The actuator-engagement member is moveable from an unengaged position, in which movement of the actuator is unimpeded, to an engaged position in which the actuator-engagement member engages with the actuator so actuated and inhibits dislodgment thereof.

### BRIEF DESCRIPTION OF DRAWINGS

The invention will be more readily understood from the following description of preferred embodiments thereof-given, by way of example only, with reference to the accompanying drawings, in which:

FIG. 1 is a top, rear perspective view of a walker apparatus partially in fragment, the walker apparatus including a pair of telescoping upright members and a pair of coupling assemblies coupling together respective ones of the upright members, the coupling assemblies including rockers and rocker covers therefore, the covers being shown in closed, engaged positions in which actuator portions of the rockers are engaged by the covers;

FIG. 2 is an enlarged rear, side perspective view of the walker apparatus of FIG. 1 partially in fragment;

FIG. 3 is an enlarged bottom, side perspective view of one of the coupling assemblies of FIG. 1, together with the upright members of the walker apparatus, the upright members being shown in fragment;

FIG. 4 is a rear perspective view of the assembly of FIG. 3, together with part of the walker apparatus of FIG. 1 shown in fragment, with the rocker cover being shown in an open, unengaged position;

FIG. 5 is a rear perspective of the assembly of FIG. 4, with the rocker being shown partially in ghost to reveal interior contents of the assembly, and with a lower one of the upright members being shown in fragment;

FIG. 6 is an exploded view of the assembly of FIG. 3, together with the lower one of upright members of the walker apparatus shown in fragment;

FIG. 7 is a rear side perspective view of a pair of telescoping upright members of a walker apparatus shown in fragment and a coupling assembly coupling the upright members according to a second aspect, the coupling assembly including a rocker, a rocker cover therefore and a mount, the cover and a hinge pin therefore being shown in an exploded view;

FIG. 8 is a rear, side perspective view of the walker apparatus and assembly of FIG. 7, with the rocker cover being shown hingedly connected to the mount and in a closed, engaged position in which the rocker cover engages an actuator portion of the rocker;

FIG. 9 is a rear, side perspective view of a pair of telescoping upright members of a walker apparatus shown in fragment and a coupling assembly coupling the upright members according to a third aspect, the coupling assembly including a rocker, a rocker cover therefore and a mount, the cover being shown in a lower position and in the process of coupling to a hinge mechanism of the mount;

FIG. 10 is a rear, side perspective view of the walker apparatus and assembly of FIG. 9, with the rocker cover being shown abutting hinge portions of the mount and with a pin member being shown in an exploded view;

FIG. 11 is a rear, side perspective view of a pair of telescoping upright members of a walker apparatus shown in fragment, and a coupling assembly coupling the upright members according to a fourth aspect, the coupling assembly including a rocker, a rocker cover therefore and a mount, the cover being shown in an exploded view;

FIG. 12 is a rear, side perspective view of the walker apparatus and assembly of FIG. 11, with the rocker cover being shown abutting hinge portions of the mount and with a pair of images of a pin member being shown in an exploded view and in the process of being compressed; and

FIG. 13 is a rear side perspective view of the walker apparatus and assembly of FIG. 12, with the rocker cover being shown hingedly connected to the mount and in a closed, engaged position in which the rocker cover engages an actuator portion of the rocker.

### DESCRIPTION OF THE PREFERRED EMBODIMENTS

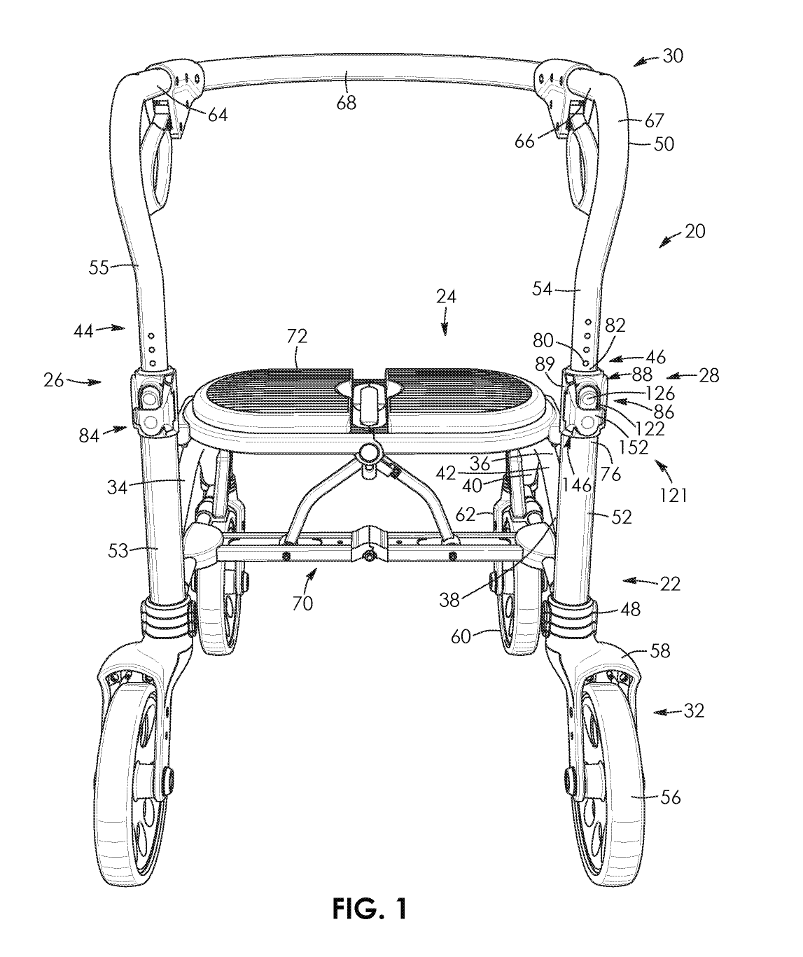

Referring to the drawings and first to FIG. 1, there is shown a walker apparatus 20. The apparatus has a front 22, a rear 24 opposite the front, a pair of spaced-apart sides 26 and 28, a top 30 and a bottom 32 that is spaced-apart from the top. The front 22 and rear 24 of the walker apparatus extend between the sides 26 and 28 thereof and the top 30 and bottom 32 thereof. The top and bottom of the apparatus also extend between the sides 26 and 28 thereof.

The walker apparatus 20 comprises a pair of spaced-apart, arc-shaped support members 34 and 36. The support members align with respective ones of the sides 26 and 28 of the walker apparatus and extend from near the bottom 32 to the top 30 thereof. Each of the support members has a proximal end, a distal end and an apex interposed between said ends in this example, as seen by proximal end 38, distal end 40 and apex 42 for support member 36.

The walker apparatus includes a pair of spaced-apart upright assemblies 44 and 46 aligning with respective ones of the sides 26 and 28 thereof. Each of the upright assemblies has a lower end and an upper end as seen by lower end 48 and upper end 50 for assembly 46. Each of the upright assemblies is height adjustable in this example and telescopic, with a lower, outer elongate member or tube and an upper, inner elongate member or tube shaped to fit within the lower tube, as seen by outer tube 52 and inner tube 54 for assembly 46 and outer tube 53 and inner tube 55 for assembly 44.

The walker apparatus 20 includes a first, pair of ground-engageable wheels operatively coupled to and rotatable relative to the lower ends of the upright assemblies, as seen by wheel 56 connected to end 48 of assembly 46 via wheel fork 58. The walker apparatus 20 also includes a second pair of ground-engageable wheels operatively coupled to and rotatable relative to the distal ends of the support members, as seen by wheel 60 connected to end 40 of support member 36 via wheel fork 62.

The walker apparatus 20 includes a pair of spaced-apart, horizontally-extending elongate handles 64 and 66 which extend along the top 30 thereof and between the front 22 and rear 24 thereof. The handles are generally j-shaped in this example, with curved portions 67 thereof coupled to respective ones of the upper ends 50 of the upright, assemblies 46. The walker apparatus 20 includes an arcuate-shaped backrest 68 in this example, only partially shown in FIG. 1, positioned along the rear 24 thereof. The backrest is in the shape of a flexible strap in this example and extends between and couples together the handles 64 and 66.

The walker apparatus 20 includes a folding, mechanism 70. The folding mechanism couples to and extends-between the support members 34 and 36. The folding mechanism 70 is configured to enable to the walker apparatus 20 to selectively fold laterally. The walker apparatus includes a seat assembly 72 that extends between and couples to the apexes 42 of the support members 34 and 36 in this example.

The walker apparatus 20 described to this stage is directed to one example of a walker apparatus and walker apparatuses of other shapes and configurations are possible, as would be clear to one skilled in the art. For example, the support members, handles, backrest, folding mechanism, wheel assemblies and seat assembly of the walker apparatuses set out in U.S. Pat. No. 8,083,239 and U.S. patent application Ser. No. 14/193,806 (shown in United States Patent Application Publication No. 2015-0245973) could be used in other embodiments, the disclosures of which are incorporated herein by reference.

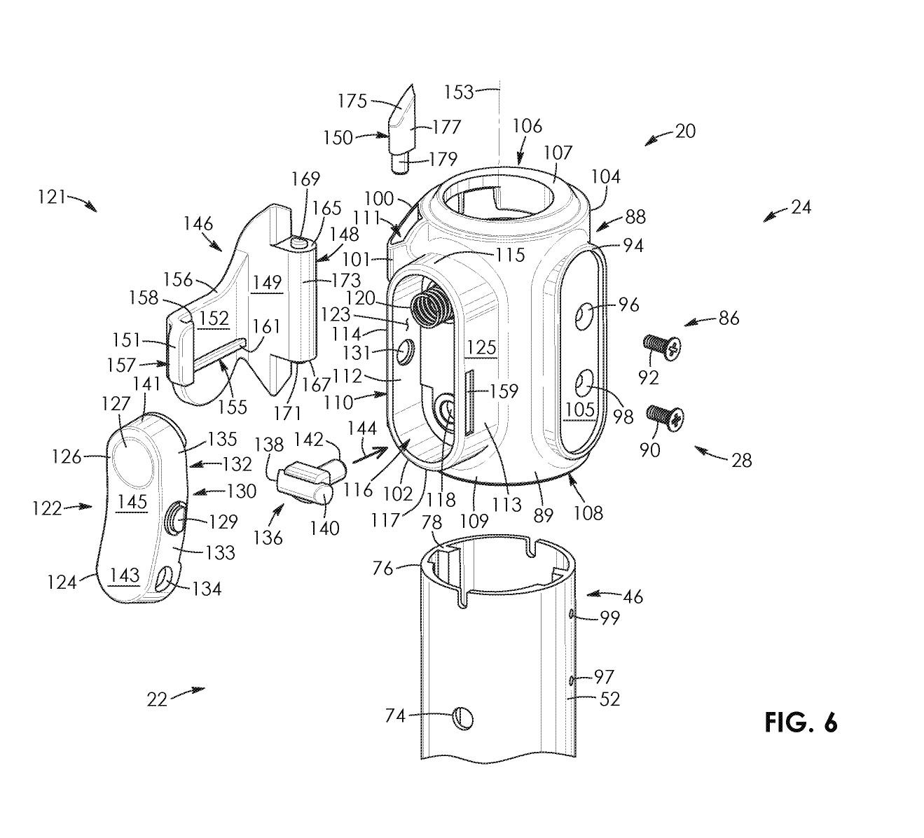

Each of the outer tubes 52 of the upright assemblies 44 and 46 has a front aperture extending therethrough. In this example the aperture is adjacent to the upper end of its outer tube, as seen in FIG. 6 by aperture 74 extending through tube 52 adjacent to upper end 76 thereof. The outer tubes further include a plurality of circumferentially spaced-apart, inwardly extending elongate protuberances 78. In this example the protuberances extend from the upper end 76 of the outer tubes towards the bottom 32 of the walker apparatus 20 seen in FIG. 1. Each of the protuberances is generally in the shape of a rectangular prism in this example.

As seen in FIG. 1, inner tubes 54 have a plurality of vertically aligned longitudinally spaced-apart apertures extending therethrough from lower ends thereof towards the upper ends 50 of the upper right assemblies 44 and 46. This is shown by aperture 80 adjacent to lower end 82 of tube 54 in FIG. 1.

The walker apparatus 20 includes a pair of coupling assemblies 84 and 86 for selectively coupling together the tubes 52 and 54 of the upright assemblies 44 and 46.

As seen in FIG. 6, each of the coupling assemblies 86 includes a mount 88. Each mount includes a base portion 89 that is generally tubular in this example; however, this is not strictly required and the mounts can be other shapes in other embodiments.

As seen in FIG. 6, the base portion 89 of each mount 88 includes an upper bore 106 at the top 107 thereof. The bore is circular in shape in this example to slidably receive the lower end 82 of one of the tubes 54 seen in FIG. 1 in this example. As seen in FIG. 6, the base portion of each mount 88 includes a lower bore 108 at a bottom 109 thereof. The lower bore is circular in shape in this example to receive the upper end 76 of one of the tubes 52.

The base portion of each mount is shaped to receive at least in part and couple to at least one of the tubes of its corresponding upright assembly. This is seen by base portion 89 of mount 88 for assembly 86 coupling to upper end 76 of tube 52 of upright assembly 46 via a pair of spaced-apart fasteners, in this example bolts 90 and 92. The bolts extend through an outer side 94 of the mount, into side apertures 96 and 98 of tube 52 and threadably couple to corresponding apertures 97 and 99 of tube 52 in this example.

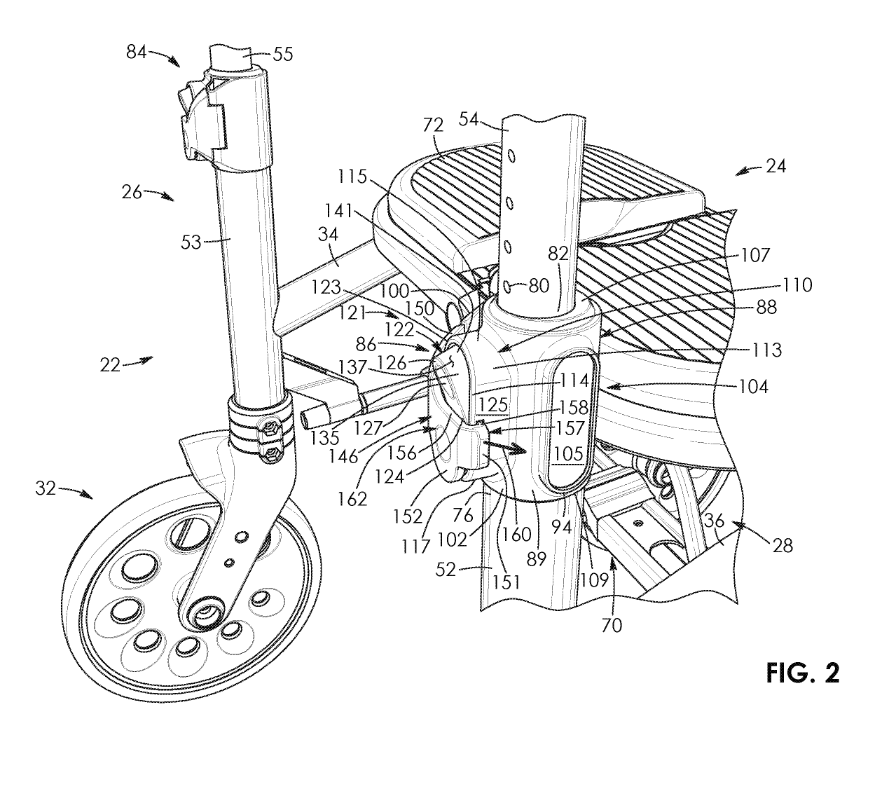

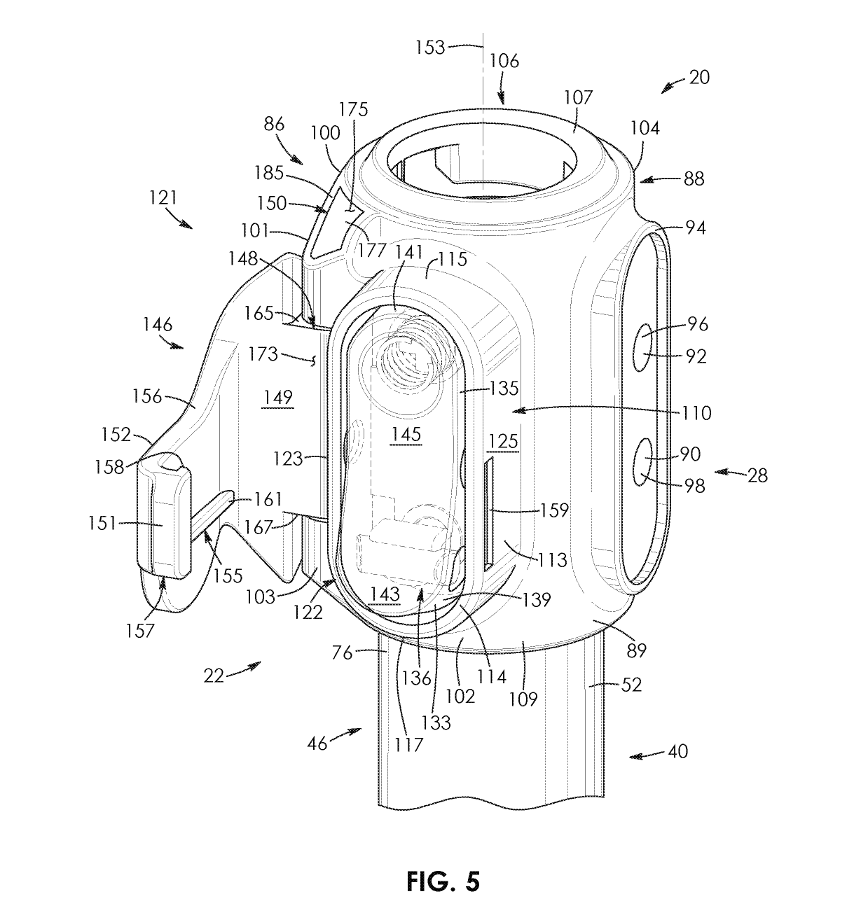

The mount 88 has an outer side 94 which aligns with respective ones of the sides 28 of the walker apparatus 20. The mount has an inner side 100 opposite its outer side, a front 102 and a rear 104 opposite its front. The sides 94 and 100 of the mounts 88 extend between the fronts and rears thereof. As seen in FIG. 2, each of the coupling assemblies 86 includes a reflector 105 which is obround in this example and which extends across and couples to the outer side 94 of its mount 88 so as to cover bolts 90 and 92 seen in FIG. 5.

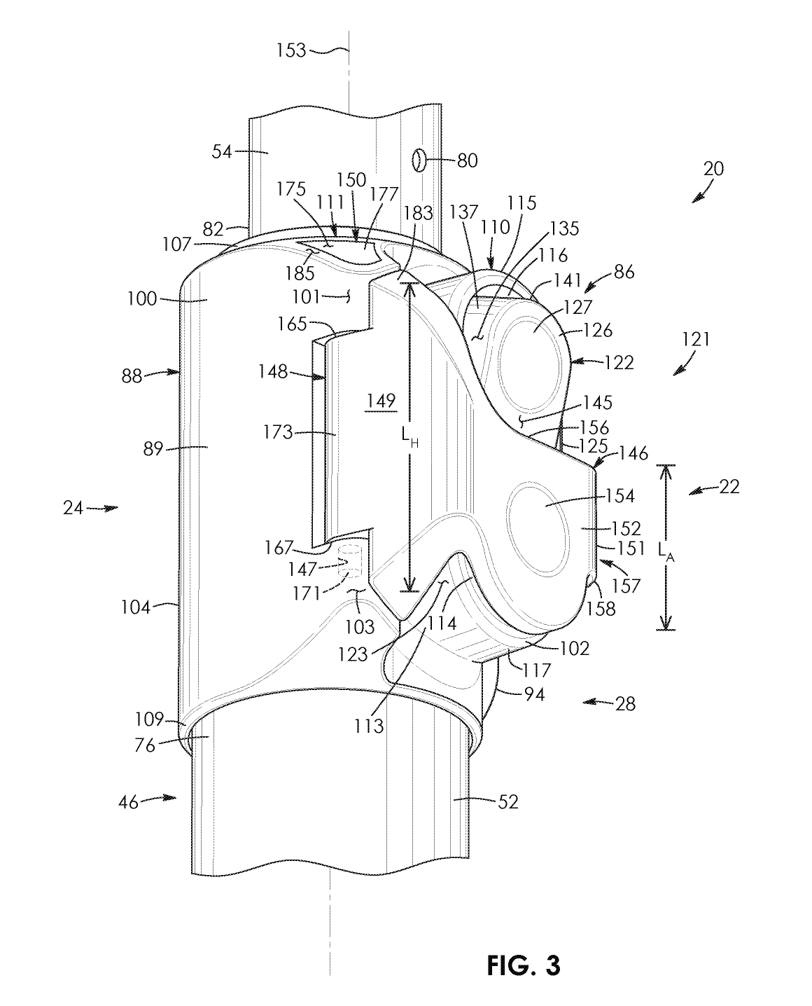

As seen in FIG. 3, the base portion 89 of each mount 88 includes upper and lower hinge members, in this example upper and lower protrusions 101 and 103. The upper protrusion is adjacent to the top 107 of the base portion of the mount and extends downwards therefrom in this example. Protrusion 101 is integrally connected to and formed with the base portion 89 of the mount 88 in this example. The upper protrusion extends outwards from inner side 100 of the mount in this example towards the front 102 of the mount. Protrusion 101 is hollow in this example and has an aperture 111 extending therethrough. The aperture extends from adjacent top 107 of the base portion 89 of the mount 88 towards the bottom 109 of the base portion of the mount in this example. Protrusion 101 has a top wall 185 that slants downwards from the side of the mount and top 107 of the base portion of the mount in this example. Aperture 111 extends through the upper protrusion via said top wall in this example.

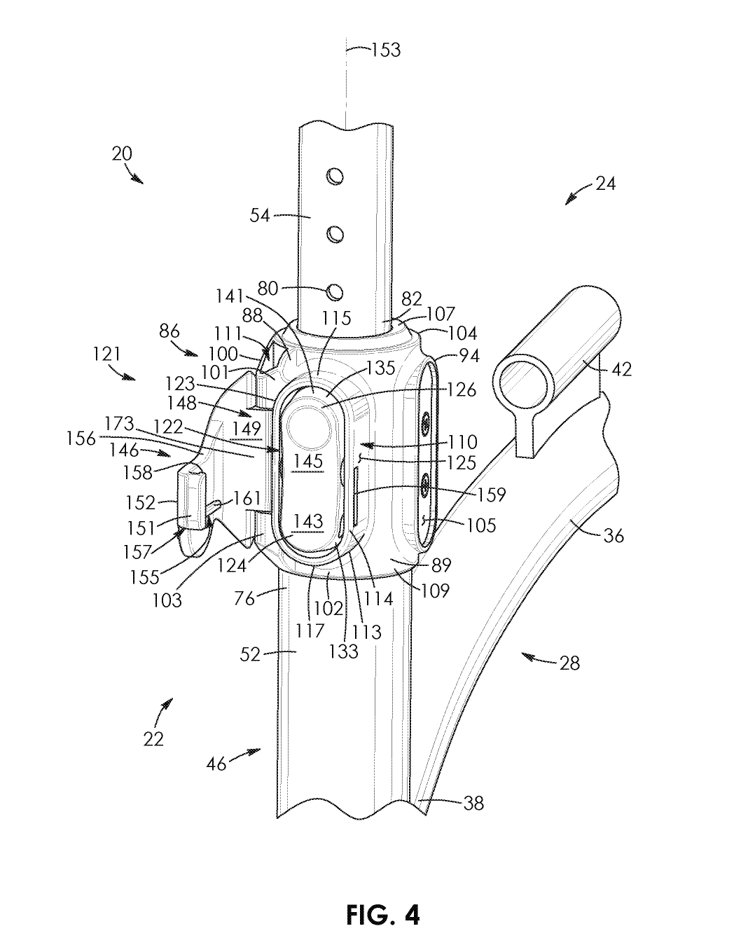

The lower protrusion 103 is adjacent to the bottom 109 of the base portion 89 of the mount 88 and extends upwards therefrom in this example. The lower protrusion is integrally connected to and formed with the base portion 89 of the mount 88 in this example. Protrusion 103 extends outwards from inner side 100 of the mount in this example towards the front 102 of the mount. The lower protrusion has a recess 147 shown in ghost in FIG. 3 and which is generally cylindrical in shape in this example. The recess faces and axially aligns with aperture 111 of upper protrusion 101 of the base portion 89 of the mount 88 in this example. The-upper and lower protrusions of the base portion of the mount are outwardly convex along, the side 100 of the mount in this example as shown by upper protrusion 101 in FIG. 4.

As seen in FIG. 6, each mount 88 includes an actuator housing, in this example a rocker housing 110. The rocker housing is integrally connected to and formed with the base portion 89 of the mount in this example. The rocker housing 110 is aligned with the front 102 of the mount and extends outwards therefrom in this example. Each of the housings is generally curved at least in part, and includes an interior 112, a housing wall 113 which extends about the interior and an open end 116 in communication with the interior.

As seen in FIG. 6, the housing wall is obround in shape in this example and has an arcuate-shaped top 115, an arcuate-shaped bottom 117 opposite the top and a pair of spaced-apart sides 123 and 125. The sides of the housing wall 113 extend between the top and bottom of the wall and are generally rectangular in shape in this example. The housing wall 113 further includes a distally-positioned peripheral edge portion 114 which extends about the top 115, bottom 117 and sides 123 and 125 thereof and which is spaced-apart from base portion 89 of the mount 88. Each mount 88 also includes a front aperture 118 which extends through its housing 110 and which is configured to align with the aperture 74 of its corresponding outer tube 52.

Each coupling assembly 86 further includes a resilient member, in this example in the form of a coil spring 120 coupled to its mount 88 at the-front 102 thereof and received within rocker housing 110 in this example. The spring 120 is adjacent to and spaced-apart above aperture 118 in this example.

As seen in FIG. 6, each of the coupling assemblies 86 includes a locking mechanism 121. Each locking mechanism includes a push-responsive actuator in this example in the form of a rocker 122. In other embodiments, the actuator could be a push-button, for example. As seen in FIG. 4, each of the rockers is generally obround in front-profile in this example. The rocker is shaped to be partially received within its rocker housing 110. The housing wall 113 extends about the rocker 122 and open end 116 of the housing 110 may be referred to as an opening of the housing wall within which the rocker is received.

Thus, each rocker is thus received within its mount 88. Referring to FIG. 6, each of the rockers includes a lower half or first portion 124 and an upper half or second portion 126 spaced-apart from the first portion thereof. The second portions of the rockers are inwardly angled relative to the first portions thereof in this example.

Referring to FIG. 6, portions 124 and 126 of each of the rockers 122. includes front walls 143 and 145, respectively, that are integrally connected and formed with each other and which are obtusely angled with respect to each other. Each of the front walls is semi-obround in shape in this example. As seen in FIG. 3, each of the second portions 126 of the rockers 122 has a recess 127 thereon which is semi-spherical for promoting engagement of the rocker with a user's finger. The recess 127 extends inwardly from the front wall 145 of the rocker.

As seen in FIG. 6, the portions 124 and 126 of the rockers 122 include side walls 133 and 135, respectively, integrally connected to, integrally formed with and extending outwards from front walls 143 and 145, respectively of the rockers in this example. The side walls are shaped to extend inwards towards its mount 88. Each of the side walls 133 and 135 is arcuate-shaped in this example, with side wall 133 being angled, integrally connected to and integrally formed with side wall 135 in this example. Each rocker 122 is pivotally mounted to its housing 110 in this example at a location between the first portions 124 and second portions 126 thereof via axle stubs 129 which extend outwardly from the walls of the rocker 122 at a location between walls 133 and 135 in this example. Axle stubs 129 are received within corresponding recesses 131 of housings 110. The recesses 131 extend partially into housing wall 113. This is only one example of the manner in which the rockers are pivotally coupled to their housings but is not strictly required as other ways of enabling pivoting of the rockers are possible. As seen in FIG. 2, a portion 137 of the side wall 135 of the second portion 126 of the rocker 122 extends outwards from the top 115 and sides 123 and 125 of housing wall 113 when the first portion 124 of the rocker 122 is actuated in this example. Portion 137 of the wall is generally wedge-shaped in side profile in this example.

As seen in FIG. 2, the second portion 126 of the rocker 122 has a top 141. The side wall 135 of the second portion of the rocker angles downwards at the top of the second portion of the rocker in this example when the first portion 124 of the rocker 122 is actuated. As seen in FIG. 5, the top 141 of the second portion 126 of the rocker is enclosed by housing wall 113 in this example when the second portion of the rocker is actuated.

As seen in FIG. 5, a portion 139 of the side wall 133 of the first portion 124 of the rocker 122 extends outwards from the bottom 117 and sides 123 and 125 of housing wall 113 when the, second portion 126 of the rocker 122 is actuated in this example. Portion 139 of the wall is generally wedge-shaped in side profile in this example.

As seen in FIG. 6, each rocker 122 is hollow in this example and has an interior 130 enclosed by walls 133 and 135. Each rocker further has an open end 132 facing the base portion 89 of its mount 88.

Each locking mechanism 121 includes a resilient member, in this example in the form of a spring 120. The springs are configured to align with and bias outwards the second portions 126 of the rockers 122 in this example. This promotes actuation inwardly of the first portions 124 of the rocker 122. As seen in FIG. 2, the peripheral edge portion 114 of housing wall 113 aligns with the first portion 124 of the rocker 122 when the first portion of the rocker is actuated. The peripheral edge portion of the housing wall is substantially flush with the first portion of the rocker 122 when the rocker is actuated in this example. As seen in FIG. 6, a pair of aligned spaced-apart apertures, as seen by aperture 134, extend through the wall 133 of first portions 124 of the rockers 122 in this example. The apertures are positioned adjacent to the bottom 117 of housing wall 113 of housing 110 of the mount 88 in this example.

As seen in FIG. 6, each of the locking mechanisms 121 includes an inwardly-extending locking member 136 that is t-shaped in this example with outer ends 138 and 140 shaped to extend through apertures 134 of walls 133 of the portions 124 of the rockers J 22 and hingedly couple to the rockers, as seen in FIG. 5. Each of the locking members further has an inner end 142 that is cylindrical in shape in this example. The inner ends of the locking members are configured to align with and selectively extend through apertures 118 of the mounts 88, apertures 74 of tubes 52, and selectively ones of apertures 80 of tubes 54 seen in FIG. 4 for selectively securing, together tubes 52 and 54. The locking member 135 hi ay be referred to as a lockpin.

Thus, pressing first portions 124 of the rockers 122 causes inward movement of locking member 136, as seen-by arrow of numeral 144 in FIG. 6. The locking member as a result extends through apertures 118, 74 and 80 seen in FIGS. 3 and 6 for coupling of the tubes together. Spring-biased second portions 126 of the rockers 122 are configured to promote actuation or inward movement of the first portions of the rockers.

As seen in FIG. 6, each of the coupling assemblies 86 further includes an actuator-engagement member, in this example in the form of a rocker cover 146. Each of the rocker covers is generally L-shaped in front profile-in this example; however, this shape is not strictly required and the rocker cover can have other shapes in other embodiments.

As seen in FIG. 6, each of the rocker covers 146 includes a hinge assembly 148. The hinge assembly has an upper end 165 and a lower end 167 spaced-apart from the upper end. The hinge assembly 148 includes an inner or hinge portion 173. A bore 169 extends into the hinge portion 173 of each rocker cover 146 in this example at the upper end 165 of the hinge assembly 148. The bore is cylindrical in this example. A pin member 171 couples to and extends downwards from the hinge portion 173 adjacent to the lower end 167 of the hinge assembly 148 of the rocker cover 146 in this example. The pin member is also cylindrical in this example.

As seen in FIG. 3, hinge portion 173 is positionable between the protrusions 101 and 103 of the base portion 89 of the mount 88. As seen in FIG. 3, pin member 171 is insertable within recess 147 of protrusion 103, with the hinge portion 173 abutting protrusion 103 adjacent to the lower end 167 of hinge assembly 148. Upper end 165 of the hinge assembly 148 abuts 101.

As seen in FIG. 6, the hinge assembly 148 further includes a pin member 150. The pin member includes a top wall 175 and an upper portion 177 extending downwards from said top wall. The upper portion of the pin member seen in FIG. 5 is shaped to fit within aperture 111 of the upper protrusion 101 of the base portion 89 of the mount 88 seen in FIG. 4. As seen in FIG. 3, the top wall 175 of the pin member 150 slants downwards in this example and is shaped to be streamlined with top wall 185 of protrusion 101 of the base portion 89 of the mount 88 in this example when the pin member is so inserted within the hinge assembly 148.

As seen in FIG. 6, the pin member 150 includes a lower portion 179 that is smaller in cross-section than the upper portion 177 thereof. The lower portion of the pin member is cylindrical in shape in this example and configured to fit within and the bore 169 of hinge portion 173 of the rocker cover 146. As seen in FIG. 5, each of the-rocker covers 146 is thus hingedly connected to the base portion 89 of its mount 88 adjacent to the inner side 100 in this example and front 102.

Each rocker cover 146 further includes a first side wall 149 which extends outwards from the hinge portion of the cover. The side wall of the rocker cover is generally in the shape of an isosceles trapezoid in this example. Side wall 149 generally extends in parallel with inner side 100 of mount 88 in this example.

Referring, back to FIG. 6, each of the rocker covers 146 includes an actuator portion, in this example a front wall 152. The front wall is semi-obround in shape in this example. The front wall 152 of the rocker cover 146 is integrally formed with and extends substantially perpendicular to side wall 149 of the cover in this example. The front wall 152 is shaped to extend over, operatively abut and press the first portion 124 of its rocker 122 when the cover is in its closed position seen in FIGS. 1 to 3. The front wall of the rocker cover 146 extends in parallel with and covers the front wall 143 of the rocker 122 when the rocker-engagement member is in the engaged position seen in FIG. 3 in this example.

As seen in FIG. 6, each rocker cover 146 includes an elongate member, in this example in the form of a rib 155. The rib is generally a rectangular prism in shape in this example. The rib 155 is integrally connected to and extends, outwards from wall 152 of the cover 146. The rib extends generally horizontally in this example. Each rib 155 has a peripheral edge portion 161 shaped to extend along and abut front wall 145 of the first portion 124 of its corresponding rocker 122 in the engaged position in this example. In this example, the peripheral edge portion of the rib is positioned to abut the front wall 143 of the first portion of the rocker at a location adjacent to the front wall 145 of the second portion 126 of the rocker.

As seen in FIG. 3, the side wall 149 of the cover 146 has a longitudinal length L_{B} extending parallel to the longitudinal axis 153 of the tubes 52 and 54. The front wall 152 of the cover has a longitudinal length L_{A} extending parallel with axis 153 in this example. The length L_{A} of the front wall of the cover is generally half the length L_{B} of the side wall 149 of the cover in this example. The front wall of the rocker cover 146 is shaped to align with and extend across the lower half of the rocker. As seen in FIG. 3, the front wall 152 of the rocker cover is one, half of an obround in shape in this example. The front wall 152 of the rocker cover has an inwardly-extending recess 154 thereon in this example which is semi-spherical for gripping of the cover with one's finger.

The rocker cover 146 is shaped to extend over and abut the first portion .124 of the rocker and expose and remain free of the second portion 126 of the rocker when the rocker cover is in its closed position seen in FIG. 2. As seen in FIG. 3, the rocker cover selectively couples to and abuts the peripheral edge portion 114 of the housing wall 113 adjacent to the first portion 124 of the rocker 122 when the rocker cover is in its closed, engaged position.

As seen in FIG. 3, the rocker cover 146 includes an upper peripheral edge 156 which extends downwards from the top 183 of side wall 149 to the front wall 152 thereof and which somewhat is s-shaped in this example. The upper peripheral edge of the rocker cover is adjacent to and positioned below the second portion 126 of the rocker 122. The upper peripheral edge 156 of the rocker cover 146 is adjacent to, aligned with and streamlined with top wall 185 of upper protrusion 101 of the base portion 89 of the mount 88 in this example.

As seen in FIG. 4, each rocker cover 146 includes a second side wall 151 in this example which is integrally connected to, is integrally formed with and which extends from front wall 152 thereof. The wall is generally in the shape of a rectangular prism in tills example. The side wall 151 extends generally in parallel with side-wall 149 in this example and extends perpendicular to front wall 152 of the rocker cover 346 in this example.

As seen in FIG. 2, each coupling assembly includes a catch mechanism as shown by catch mechanism 157 for assembly 86. Rocker cover 146 selectively couples to mount 88 and abuts rocker 122 via said catch mechanism. Each catch mechanism 157 includes a catch 158 that in this example is a part of rocker cover 146. The catch is integrally connected to, is integrally formed with and extends outwards from side wall 151 in this example. Each of the catches is generally a rectangular prism in shape in this example and extends inwards and perpendicular to its side wall 151 when the cover is in the closed position. As seen in FIG. 6, rib 155 extends between side walls 149 and 151 of the rocker cover 146 in this example.

As shown in FIG. 6, each catch mechanism 157 includes a recess, in this example an elongate slot 159 extending through housing wall 113 at side 125 thereof and adjacent to bottom 117 thereof in this example. The slot is positioned adjacent to peripheral edge portion 114 of the housing wall. Each of the catches 158 is shaped to selectively extend through its respective slot and couple to the peripheral edge portion 114 of housing wall 113 when the cover is in the closed position. The catch 158 thus operatively couples to tubes when the rocker cover is in the engaged position.

Put another way, the rocker cover is arcuate-shaped in cross-section in this example and is arcuate-shaped in a direction facing the rocker 122 when the cover is in the closed position. Thus, the rocker cover 146 is outwardly concave oh a side facing the rocker in its closed position. The cover extends about the rocker housing 110 as seen by arrow of numeral 160 in FIG. 2 when the cover is pushed inwards. The rocker cover 146 is thus shaped to snap fit with the rocker housing in the closed, engaged position of the cover.

The above catch/latch description is one example only of a suitable coupling mechanism and the rocker cover may selectively actuate the rocker in other manners in other embodiments. Also, in other embodiments, the catch may be coupled to and integrally formed with the housing wall 113 of the mount 88, for example, with a slot extending through a corresponding portion of the rocker coyer 146 for selectively coupling the rocker cover and housing wall together.

The rocker cover 146 is moveable from an unengaged or open position seen in FIG. 4, in which the front wall 152 thereof is spaced-apart from the rocker 122 so movement of the rocker is unimpeded, to an engaged or closed position, seen in FIG. 2, where the cover extends across and presses the first portion 124 of the rocker. The rocker cover 146 is thus shaped to at least partially cover the open end 116 of the housing 110 when in the engaged position. As seen in FIG. 3, the rocker cover 146 is shaped to extend along the sides 123 and 125 of the housing wall 113, along open end 116 of the housing 110 and adjacent to the top or bottom of the housing wall, in this example bottom wall 117, when the rocker cover is in the closed, engaged position.

As seen in FIG. 3, rocker 122 is positioned between side walls 149 and 151 and between hinge assembly 148 and catch 158 when the rocker cover 146 is in the engaged position. The cover 146 thus functions as a safety mechanism for ensuring that the rocker remains in its locked position, couples the tubes 52 and 54 together, and inhibits outward slippage or dislodgement of locking member 136. Rocker cover 146 acts as and may be referred to as a means for promoting actuation of the rocker, with said means inhibiting dislodgement of the rocker.

When rocker cover 146 is in its open position seen in FIG. 4, pressing of the second portion 126 of the rocker 122 inwards causes the first portion 124 of the rocker to move outwards and thereby allows the tubes 52 and 54 to move freely relative to each other.

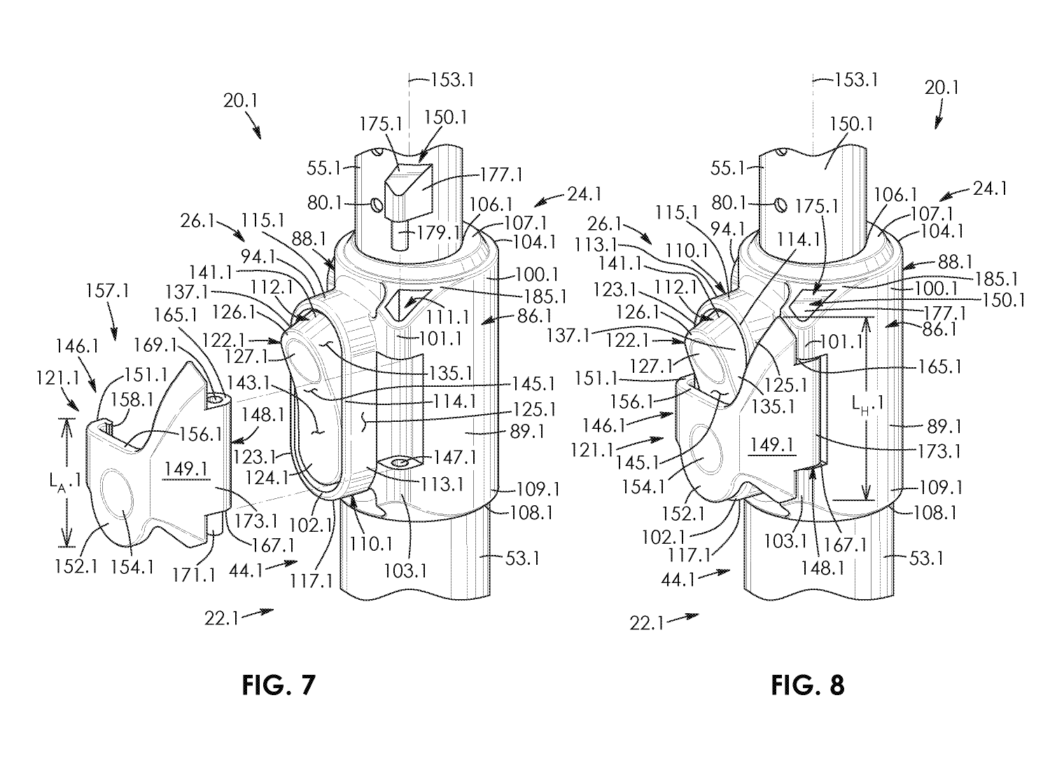

FIGS. 7 and 8 show a walker apparatus 20.1 and coupling assembly 86.1 according to a second aspect. Like parts have like numbers and functions as the walker apparatus 20 and coupling assemblies 86 shown in FIGS. 1 to 6 with the addition of decimal extension “0.1”. Apparatus 20.1 and assembly 86.1 are the same as described for apparatus 20 and assembly 86 shown in FIGS. 1 to 6 except that the upper protrusion 101.1 and lower protrusion 103.1 of the base portion 89.1 of the mount 88.1 are outwardly concave along the side 100.1 of the mount.1 in this example.

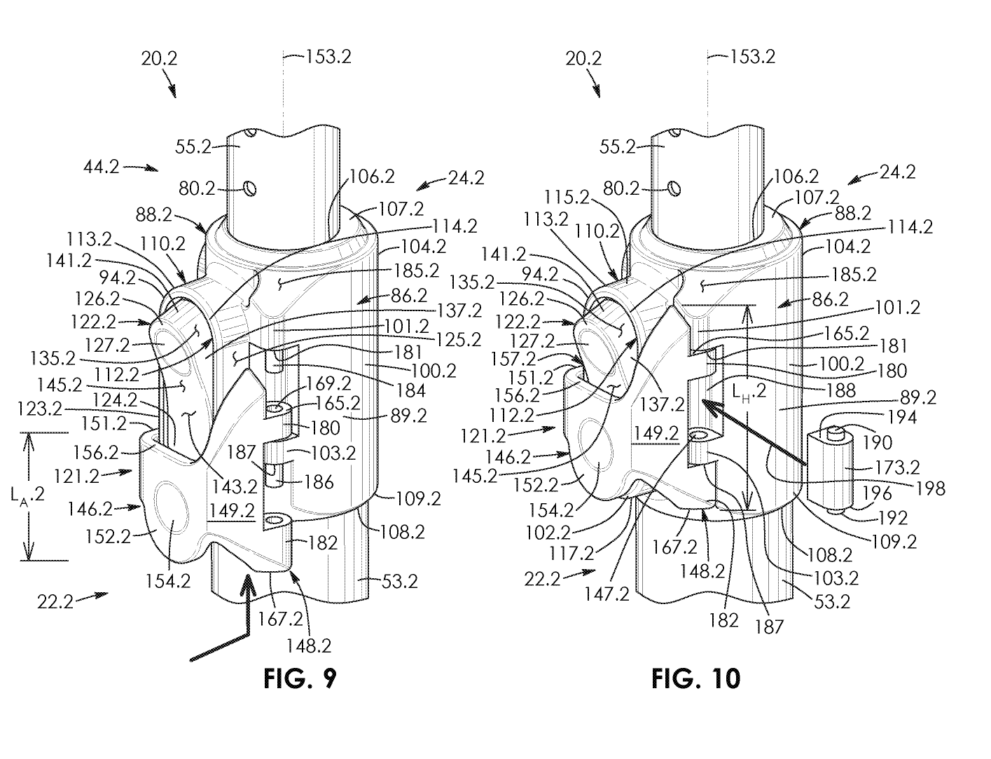

FIGS. 9 and 10 show a walker apparatus 20.2 and coupling assembly 86.2 according to a third aspect. Like parts have like numbers and functions as the walker apparatus 20.1 and coupling assembly 86.1 shown in FIGS. 7 and 8 with decimal extension “0.2” replacing decimal extension “0.1” and being added for similar parts not previously having decimal extensions. Apparatus 20.2 and assembly 86.2 are the same as described for apparatus 20.1 and assembly 86.1 shown in FIGS. 7 and 8 with the following exceptions.

In this embodiment and as seen in FIG. 9, the hinge assembly 148.2 of rocker cover 146.2 includes a pair of spaced-apart upper and lower sleeves 180 and 182. Upper sleeve 180 is adjacent to the upper end 165.2 of the hinge assembly. Lower sleeve 182 is adjacent to the lower end 167.2 of the hinge assembly 148.2. The sleeves 180 and 182 are integrally connected to and formed with the side wall 149.2 of the rocker cover 146.2 in this example.

As seen in FIG. 9, the upper protrusion 101.2 of the base portion 89.2 of the mount 88.2 includes a pin member 184 coupled thereto and extending downwards from the bottom 181 of the protrusion in this example. The lower protrusion 103.2 of the base portion of the mount includes a pin members 186 coupled thereto and extending downwards from the bottom 187 of the protrusion in this example. Pin members 184 and 186 are cylindrical in shape in this example and are configured to be received within. sleeves 180 and 182, respectively, of the hinge assembly 148.2 of the rocker cover 146.2. As seen in FIG. 10, the upper end 165.2 of the hinge assembly abuts bottom 181 of protrusion 101.2 of the base portion 89.2 of the mount 88.2 in this example when the rocker cover 146.2 is hingedly coupled to the mount. Bottom 187 of protrusion 103.2 abuts with sleeve 182 also in this configuration. As seen in FIG. 10, a recess 188 is provided in this example between upper sleeve 180 of the hinge assembly 148.2 and lower protrusion 103.2 of the base portion 89.2 of the mount 88.2 when the rocker cover hingedly couples to the mount.

Hinge portion 173.2 of hinge assembly 148.2 of the rocker cover 146.2 is a removable component of the assembly. The hinge portion has a pair of spaced-apart upper and lower pin members 190 and 192 coupled to and extending outwards from the upper and lower ends 194 and 196 of the hinge portion, respectively. The hinge portion 173.2 is selectively insertable within recess 188, as shown by arrow of numeral 198, with pin member 190 being pivotally received within upper sleeve 180 and pin member 192 being pivotally received within recess 147.2 of lower protrusion 103.2 of the base portion 89.2 of the mount 88.2 in this example.

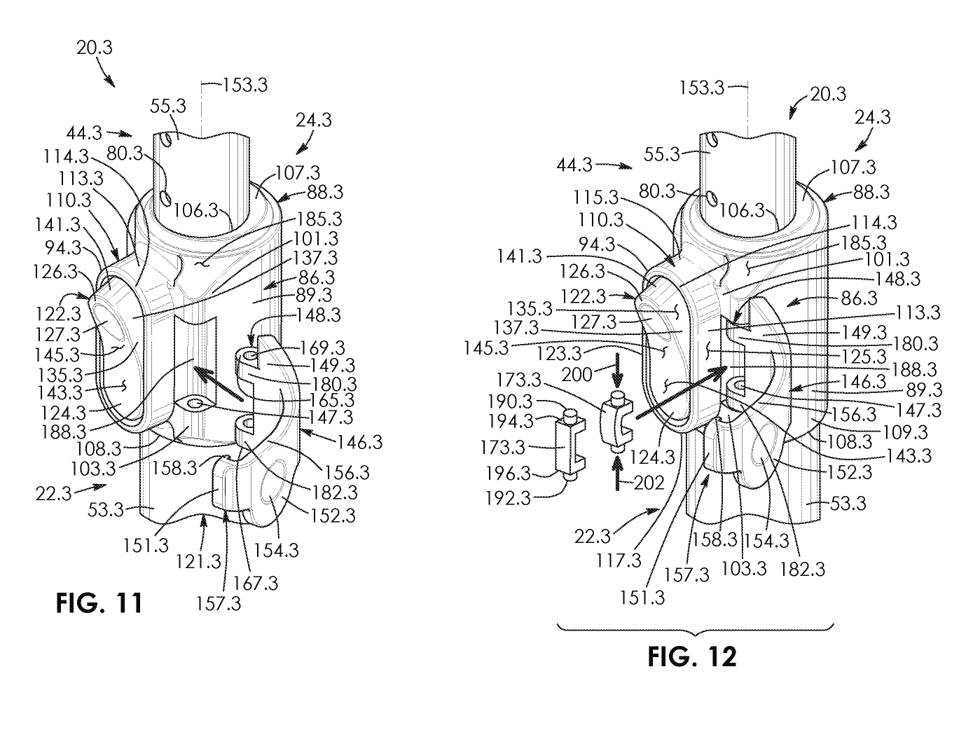

FIGS. 11 to 13 show a walker apparatus 20.3 and coupling assembly 86.3 according to a fourth aspect. Like parts have like numbers and functions as the walker apparatus 20.2 and coupling assembly 86.2 shown in FIGS. 9 and 10 with decimal extension “0.3” replacing decimal extension “0.2” and being added for similar parts not previously having decimal extensions. Apparatus 20.3 and assembly 86.3 are the same as described for apparatus 20.2 and assembly 86.2 shown in FIGS. 9 and 10 with the following exceptions.

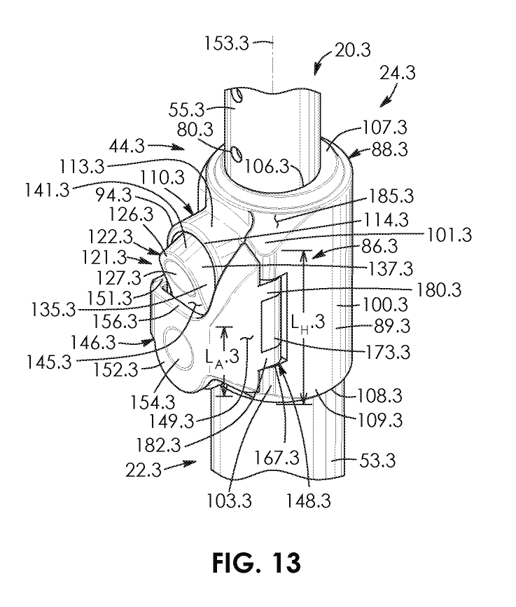

As seen in FIG. 12, sleeves 180.3 and 182.3 of hinge assembly 148.3 abut and are received between upper and lower protrusions 101.3 and 103.3, respectively of the base portion 89.3 of the mount 88.3 in this example. Hinge portion 173.3 of the hinge assembly is u-shaped in this example when viewed from a side, is made of a resilient material in this example and is selectively compressible as shown by arrows of numerals 200 and 202. The hinge portion is insertable within recess 188.3 by first compressing the hinge longitudinally and thereafter fitting pin members 190.3 and 192.3 within sleeves 180.3 and 182.3, respectively. Thereafter, the hinge portion expands back into its normal shape as seen in FIG. 13, with the pin members being resiliency biased outwards to promote coupling to the sleeves.

It will be appreciated that many variations are possible within the scope of the invention described herein. It will also be, understood by someone skilled in the art that many of the details provided above are by way of example only and are not intended to limit the scope of the invention which is to be determined with reference to at least the following claims.

What is claimed is:

1. An assembly for selectively inhibiting movement of elongate members of a walker apparatus relative to each other, the assembly comprising:
a push-responsive actuator actuation of which inhibits movement of the elongate members relative to each other; and
an actuator-engagement member operatively coupled to the actuator, the actuator-engagement member being moveable from an unengaged position, in which movement of the actuator is unimpeded, to an engaged position in which the actuator-engagement member engages with the actuator so actuated and inhibits dislodgment thereof.

2. The assembly as claimed in claim 1, wherein the push-responsive actuator includes a first portion, actuation thereof inhibiting movement of the elongate members relative to each other, and wherein the actuator-engagement member in said engaged position extends across and actuates the first portion of the actuator.

3. The. assembly as claimed in claim 1 further including a mount within which the actuator is received, the actuator-engagement member being shaped to snap fit with said mount in the engaged position of the actuator-engagement-member.

4. The assembly as claimed in claim 3 wherein the mount includes a housing wall extending about the actuator and wherein the actuator-engagement member includes a catch that couples to a peripheral edge portion of the housing in the engaged position.

5. The assembly as claimed in claim 1 further including a housing wall having an opening within which the actuator is received, the actuator-engagement member being shaped to at least partially enclose said opening of the housing wall when in the engaged position.

6. The assembly as claimed in claim 5 wherein the housing wall has a top, a bottom opposite the top and a pair of spaced-apart sides, the actuator-engagement member being shaped to extend along the sides, the opening and at one of the top and bottom of the housings/all when the actuator-engagement member is in the engaged position.

7. The assembly as claimed in claim 2 further including a housing wall extending about the actuator, the housing wall including a peripheral edge portion that is substantially flush with the first portion of the actuator when the actuator is actuated, the actuator-engagement member selectively abutting the peripheral edge portion of the housing wall adjacent to the first portion of the actuator when the actuator-engagement member is in the engaged position.

8. The assembly as claimed in claim 2, wherein the actuator has a second portion spaced-apart from the first portion thereof, and wherein the assembly further includes a mount in which the actuator is received, the actuator pivotally connecting to the mount at a location between the first and the second portions thereof, the second portion of the actuator being spring-biased outwards for promoting actuation of the first portion of the actuator inwards.

9. The assembly as claimed in claim 1, wherein at least one of the elongate members has one or more apertures extending therethrough, and wherein the assembly Further includes an inwardly-extending locking member operatively coupled to the actuator, the locking member being shaped to extend through respective ones of said apertures when the actuator is actuated.

10. The assembly as claimed in claim 2 wherein the actuator has a second portion spaced-apart from the first portion thereof, actuation of the second portion of the actuator causing the first portion of the actuator to move outwards when the actuator-engagement member is in the unengaged position and thereby enabling the elongate members to move freely relative to each other.

11. The assembly as claimed in claim 10 wherein the actuator-engagement member is shaped to extend over and abut the first portion of the actuator and remain free of the second portion of the actuator when the actuator-engagement member is in the engaged position.

12. The assembly, as claimed in claim 1 wherein the actuator-engagement member is generally L-shaped in front profile.

13. The assembly as claimed in claim 1 further including a mount operatively connected to at least one of the elongate members, the actuator being received within the mount, and wherein the actuator-engagement member includes a hinge portion hingedly connected to the mount and an actuator portion shaped to actuate at least a portion of the actuator when the actuator-engagement member is in the engaged position.

14. The assembly as claimed in claim 1 further including a catch mechanism, the actuator-engagement member and the actuator selectively abutting each other via said catch mechanism when the actuator is so actuated.

15. The assembly as claimed in claim 1 wherein the actuator is a rocker that is generally obround in front-profile, the rocker including a spring-biased second portion configured to promote actuation of the first portion thereof and wherein the actuator-engagement member is generally semi-obround in shape.

16. The assembly as claimed in claim 1 wherein the actuator-engagement member includes a rib that abuts at least a portion of the actuator when in the engaged position.

17. In combination, a walker apparatus and the assembly as claimed in claim 1.

18. An assembly for inhibiting movement of elongate members of a walker apparatus relative to each other, the assembly comprising:
a push-responsive actuator;
a lockpin operatively connected to the actuator, actuation of the actuator causing the lockpin to couple together the elongate members; and
an actuator-engagement member connectable to one of the elongate members, the actuator-engagement member being moveable from an Unengaged position, in which movement of the actuator is unimpeded, to an engaged position in which the actuator-engagement member engages with the actuator so actuated and inhibits dislodgement thereof.

19. In combination, a walker apparatus and the assembly as claimed in claim 18.

20. A walker apparatus comprising:
a pair of telescoping elongate members; and
a coupling assembly including a push-responsive actuator actuation of which couples together the elongate members, and an actuator-engagement member coupled and pivotable relative to one of the elongate members, the actuator-engagement member being moveable from an unengaged position, in which movement of the actuator is unimpeded, to an engaged position in which the actuator-engagement member engages with the actuator so actuated and inhibits dislodgement thereof.
